(19) United States
(12) Patent Application Publication
(10) Pub. No.: US 2005/0210273 A1
(43) Pub. Date: Sep. 22, 2005

(54) Secure electronic message system

(75) Inventors: James D. Gersten, Mason, OH (US); Phillip E. Huff, Liberty Township, OH (US); Roland K. Foreman, Mason, OH (US)

Correspondence Address: WOOD, HERRON & EVANS, LLP, 2700 CAREW TOWER, 441 VINE STREET, CINCINNATI, OH, 45202, US

(73) Assignee: eLynx, Ltd.

(21) Appl. No.: 10/802,165

(22) Filed: Mar. 17, 2004

(51) Int. Cl. H04L 9/32

(52) U.S. Cl. 713/189

(57) ABSTRACT

A method, apparatus and program product provide a mechanism for communicating an encrypted package over a secure network connection. The package is communicated via a https secure socket layer network connection. The package is generated using a non-browser application and includes an email analogous interface, in addition to file data and an email address associated with an addressee. The package may be encrypted at the local computer of a sender prior to being communicated over the secure network connection to a secure server.

### FIELD OF THE INVENTION

The present invention relates generally to computer operations and applications, and more particularly, to the transmission of electronic messages between computers.

### BACKGROUND OF THE INVENTION

Corporations, government agencies and private individuals place great emphasis on securing sensitive information. This need for security, however, is often at odds with a competing desire to efficiently communicate information. That is, security practices often struggle to keep pace with the growing number of data communication options available for communicating data. For instance, the popularity of the Internet and electronic mail, or email, have placed a substantial burden on administrators to safeguard sensitive data. While the efficiency, wide acceptance and familiarity of email make it indispensable in certain contexts, its availability also makes it vulnerable to unscrupulous individuals. Such persons often seek to receive, copy or alter unsecured email.

This vulnerability is largely attributable to the packet switching network connections that support most email communications. The nature of these connections makes it impractical to predict which of many servers an email will be routed through prior to reaching its destination. It is further impractical to ensure the security of all other switches, or to ensure that the portions of the message, including those that specify its source or destination, have not been read or altered en route.

Regarding such unsecured connections, security practices have developed at the transport/session layer of a computer network operating in accordance with the Transmission Control Protocol/Internet Protocol (TCP/IP) Standard. These techniques include the Secure HyperText Transport Protocol (https). Https includes a handshake-based key distribution that utilizes complex public key cryptography techniques.

Such public key techniques typically include both a public and a private key. The public key is usually unencrypted and available to any user, while the private key is kept secret. The keys are typically prime numbers that are often hundreds of digits long. The inherent strength of the algorithm of the public key system lies in the difficulty in mathematically factoring large numbers. The message is encrypted using the public key when sent. The message can then only be decrypted and read by the recipient using their private key.

In use, a customer or other user enters credit card information, for example, into preset fields of a web browser, which securely forwards the browser data to a server over the https connection. A browser is a text and/or graphic based program that communicates with a remote server on a transparent, programmatic level to pass electronic information between the server and the local computer. In response to the user entering the credit information into the preset fields of a Web browser window, a program on the server side then automatically extracts data delivered over the https connection and conveys the data to another application, such as an electronic purchase order program.

While such https socket connections are effective in delivering certain types of sensitive data, the breadth and format of data passed by the https socket remains limited by the confines of the browser application. For instance, browser applications do not allow much flexibility in their respective data entry fields when compared to the needs and expectations of most email users. Namely, browser applications are conventionally configured to only receive a relatively particular, limited type of information, such as a data string consisting of a credit card number. This data is then used to populate a corresponding field of a specific program application that receives only the extracted data string. As such, browser applications do not conventionally display data directly to a recipient at the server. Consequently, conventional browser applications do not accommodate text, image or other attachments that are included in most business and personal communications.

To this end, other secure methods have concurrently developed that allow users relatively more flexibility with regard to the types of information that can be securely exchanged. For instance, digital certificates and other tokens are commonly used to better ensure the security of transmissions. Digital certificates are encrypted files that reside on a user's hard drive and function as an Internet identification. When a person needs access to a system, that system prompts the local computer for the digital certificate instead of the password. The computer then sends the certificate in encrypted format through the network authorizing the client for access. As such, digital certificates can supplant the functionality of more easily compromised or forgotten passwords during an email or other network communication.

While such certificates can be useful in verifying the identity of a sender, certificates and other tokens nonetheless burden the sender and receiver with acquiring and installing the certificates prior to communication. New certificates must often be acquired for each new communication or addressee, and the security of the transmission remains vulnerable by virtue of an unsecured network server connections. Such efforts and persistent security concerns dissuade many email users from using digital certificates.

Consequently, and for in part the above delineated reasons, there exists a need for an improved manner of communicating sensitive information between computers.

### SUMMARY OF THE INVENTION

The present invention provides an improved apparatus, method and program product for communicating secure electronic messages in a manner that addresses the above-identified problems of conventional systems. In one respect, the invention provides a mechanism for communicating an encrypted package over a secure network connection. More particularly, the package is communicated using a https secure socket layer network connection. The package is generated using a non-browser application operating on a local computer. The generated package may include an email analogous interface, in addition to file data and an address associated with an addressee. The address is typically associated with a public email account. Where desired, the package is encrypted at the local computer of a sender prior to being communicated over the secure network connection to a secure server.

The secure server may store the package in association with the email account of the addressee. The package may subsequently be communicated to the addressee using a secure network connection, i.e., the https secure socket layer network connection. The package may then be decrypted and displayed to the addressee. Where desired, a sender may use a public key to send the package over the secure network connection. The addressee may subsequently use a private key associated with the public key to decrypt the package. Where so configured, the addressee may be notified of the package using the public email account.

In addition to accommodating user input and relating pertinent file data information, the interface presents familiar email features to the user, which encourages use. The interface may further display a status of the package to a sender, and may allow additional file data to be added to the package. File data for purposes of the specification may include data in PCL and native formats, as well as general text, digital images and audio, in addition to other recordable data. In displaying the package to the addressee, the package may be downloaded from the secure server to a local computer of the addressee. Such downloading of the package may be accomplished manually or automatically. Where appropriate, the package may also be compressed in size at the local computer of the sender.

The interface of the package provides many functional and familiar features that are analogous to a conventional email application. Such features include the ability to combine many different files and other types of data into a package without elaborate machinations. The familiarity afforded by the features of the invention allow a user to comfortably create, review, augment and modify a package as they might a conventional, non-secure email message. Another feature provides “send and receive” monitoring of the status of a package. This familiarity translates into more efficient and widespread use of the secure package transmission. In addition to the ease of use of the package delivery system, the contents of the package are protected under the auspices of the secure https socket connection, providing improved security and data integrity.

By virtue of the foregoing there is thus provided an improved design file analysis mechanism that addresses shortcomings of conventional techniques. These and other objects and advantages of the present invention shall be made apparent in the accompanying drawings and the description thereof.

### BRIEF DESCRIPTION OF THE DRAWINGS

The accompanying drawings, which are incorporated in and constitute a part of this specification, illustrate an embodiment of the invention and, together with a general description of the invention given above, and the detailed description of the embodiment given below, serve to explain the principles of the invention.

FIG. 1 is a block diagram of a client-server computer system having software consistent with the invention.

FIG. 2 is a flowchart having a sequence of steps executable by the client computer of the system of FIG. 1 for sending PCL stream data.

FIG. 3 is a flowchart having a sequence of steps executable by the client computer of the system of FIG. 1 for communicating a secure electronic message having a file in native format.

FIG. 4 is a flowchart having a sequence of steps executable by the client computer of the system of FIG. 1 for sending a package created by the processes of FIG. 2 or 3.

FIG. 5 shows an exemplary computer interface screen for displaying file data information and receiving user input pertaining to a package processed by the methods of FIGS. 2-4.

FIG. 6 shows an exemplary computer interface screen configured to display contact information pertinent to a recipient of a package communicated by the processes of FIG. 4.

FIG. 7 shows an exemplary computer interface screen configured to display information indicative of stored, draft packages generated by the processes of FIG. 2 or 3.

FIG. 8 is a flowchart having a sequence of steps executable by the server computer of the system of FIG. 1 for receiving and communicating a package sent by the processes of FIG. 4.

FIG. 9 is a flowchart having a sequence of steps executable by a local computer of an addressee for receiving a package communicated by the processes of FIG. 8.

### DETAILED DESCRIPTION OF DRAWINGS

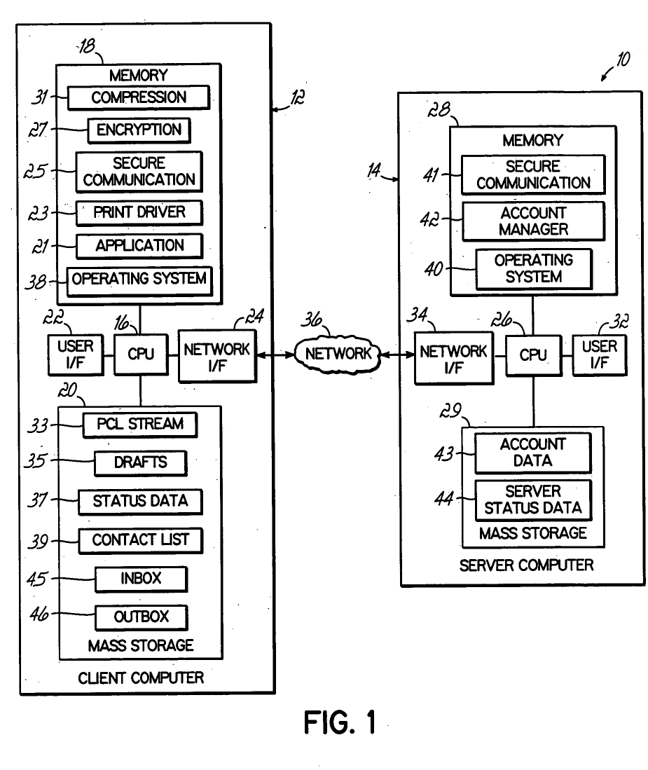

FIG. 1 illustrates a client-server based computer system 10 that is configured to communicate an encrypted email package over a secure network connection. System 10 includes at least one apparatus, e.g., one or more client computers 12 and one or more server computers 14. For the purposes of the invention, each computer 12, 14 may represent practically any type of computer, computer system or other programmable electronic device capable of functioning as a client and/or server in a client-server environment. Moreover, each computer 12, 14 may be implemented using one or more networked computers, e.g., in a cluster or other distributed computing system. As is common in many client-server systems, multiple client computers 12 will typically be interfaced with a given server computer 14. While more capable computer systems may present advantages, a suitable server 14 for purposes of this specification may comprise any device configured to receive and process an electronic message transmitted from the client computer 12.

Client computer 12 typically includes a central processing unit 16 including at least one microprocessor coupled to a memory 18, which may represent the random access memory (RAM) devices comprising the main storage of computer 12, as well as any supplemental levels of memory, e.g., cache memories, non-volatile or backup memories (e.g., programmable or flash memories), read-only memories, etc. For instance, the computer 12 may include an encryption program 27. Encryption is the process of using a mathematical algorithm to transform information into a format that is hard to read. This format is called ciphertext. Decryption is a process that uses another algorithm to transform encrypted information back into a readable format, called plain text. The memory 18 may also include a compression program 31, as well as a secure communication program 25, among others, configured to securely communicate a package over a secure connection. A print driver 23 may interface with a printer, and an application 21 may be used to generate file data. In addition, memory 18 may be considered to include memory storage physically located elsewhere in computer 12, e.g., any cache memory in a processor in CPU 16, as well as any storage capacity used as a virtual memory, e.g., as stored on a mass storage device 20 or on another computer coupled to computer 12.

Computer 12 also typically receives a number of inputs and outputs for communicating information externally. For interface with a user or operator, computer 12 typically includes a user interface 22 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 12 may also include one or more mass storage devices 20, e.g., a floppy or other removable disk drive, a hard disk drive, a direct access storage device (DASD), an optical drive (e.g., a CD drive, a DVD drive, etc.), and/or a tape drive, among others. An exemplary mass storage may include PCL stream data 33, draft packages 35, status data 37, a contact list 39, as well as an inbox 45 and outbox 46. One of skill in the art will recognize that the inclusion and distribution of the databases, files and other stored data may be altered substantially while still conforming with the principles of the present invention.

Computer 12 may include an interface 24 with one or more networks (e.g., a LAN, a WAN, a wireless network, and/or the Internet, among others) to permit the communication of information with other computers and electronic devices. It should be appreciated that computer 12 typically includes suitable analog and/or digital interfaces between CPU 16 and each of components 18, 20, 22 and 24 as is well known in the art.

Similar to computer 12, computer 14 includes a CPU 26, memory 28, mass storage 29, user interface 32 and network interface 34. However, given the nature of computers 12 and 14 as client and server, in many instances computer 14 will be implemented using a multi-user computer such as a server computer, a midrange computer, a mainframe, etc., while computer 12 will be implemented using a desktop or other single-user computer. As a result, the specifications of the CPU's, memories, mass storage, user interfaces and network interfaces will typically vary between computers 12 and 14. However, one skilled in the art will appreciate that other hardware environments are contemplated within the context of the invention.

Computers 12, 14 are generally interfaced with one another via a network 36, which may be public and/or private, wired and/or wireless, local and/or wide-area, etc. Moreover, network 36 may represent multiple, interconnected networks. In the illustrated embodiment, for example, network 36 may include the Internet.

Each computer 12, 14 operates under the control of an operating system 38, 40 and executes or otherwise relies upon various computer software applications, components, programs, objects, modules, data structures, etc. Moreover, various applications, components, programs, objects, modules, etc. may also execute on one or more processors in another computer coupled to computer 12, 14 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention.

While the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the environment illustrated in FIG. 1 is not intended to limit the present invention. Indeed, those skilled in the art will recognize that other alternative hardware and/or software environments may be used without departing from the scope of the invention. For exemplary purposes, however, much of the remaining portion of this specification addresses program flows suitable for execution by and within the context of the hardware and software environment of FIG. 1.

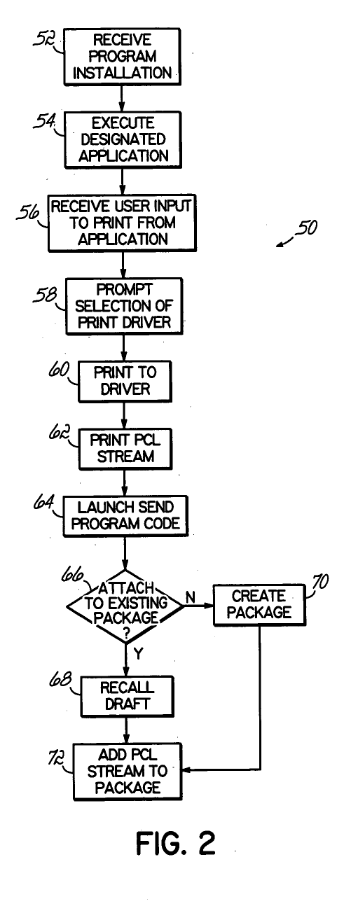

The flowchart 50 of FIG. 2 shows a series of exemplary process steps configured to generate a package that includes Printer Control Language (PCL) stream file data 33. Information produced for printing can be captured in the form of PCL, most popularly the control language promulgated by Hewlett-Packard. For example, print stream from a system may be captured as it is delivered from the printer port of a server 3. The print stream is then saved and is electronically transmitted to other locations where the printstream can then be delivered to a printer to print the desired document. A package for purposes of this specification may comprise an electronic transmission of data. Additionally, for purposes of this specification, the terms “package” and “message” may be used interchangeably. The processes of the flowchart 50 are exemplary of those that may be executed on the local client computer 12 of the system 10 of FIG. 1. For instance, the client computer 12 may initially receive installation of a program at block 52 configured to communicate a secure electronic package over a secure connection. Such a program may be downloaded from another network connection or uploaded from a compact disc or diskette, and may reside in the memory 18 of the client computer 12.

The client computer 12 may execute another computer application 21 at block 54 during the course of normal operations. One such an application 21 includes a word processing program, for instance. One skilled in the art will appreciate that the designated application 21 does not need to be actively used by the client at the time a secure package is sent, or may be running minimized, for instance.

The client computer 12 may receive input from the user at block 56 indicating that they wish to print from the designated application. Processes associated with receiving such input at block 56 may include a user clicking on or otherwise selecting a print control command from a menu of the application 21. In response, the operating system 38 of the client computer 12 may prompt a user's selection of a print driver 23 at block 58 of FIG. 2. The client computer 12 will then execute a print to driver function in response to the selection at block 60. A printer receiving the print command from the operating system 38 of the client computer 12 in response creates a PCL stream at block 62.

At block 64, the client computer 12 may then launch the program code installed at block 52 of FIG. 2. Processes initiated with the code may enable attachment of the PCL stream to a package. For instance, the operating system 38 executing the program code may initiate the display of a dialog box asking the user if they wish to attach the generated PCL stream to an existing package at block 66. An existing, or draft package may have been previously created and stored for later use by a client. Where such a draft package is available and desired at block 66, then that draft package is recalled at block 68 of FIG. 2.

Where the user alternatively does not wish to attach the generated PCL stream to an existing draft package at block 66, then the operating system 38 of the client computer 12 may create a new package at block 70. In either case, the operating system 38 executing the program code may extract relevant data from the PCL stream and add the extracted file data to the package at block 72. File data comprising multiple PCL streams may be added to the same or multiple packages in this manner. The file data added to the package is typically configured to be read only for security and data integrity considerations. Additional disclosure relating to PCL stream data is disclosed in U.S. application Ser. No. 10/702,204, which was filed on Nov. 5, 2003 and is hereby incorporated by reference in its entirety.

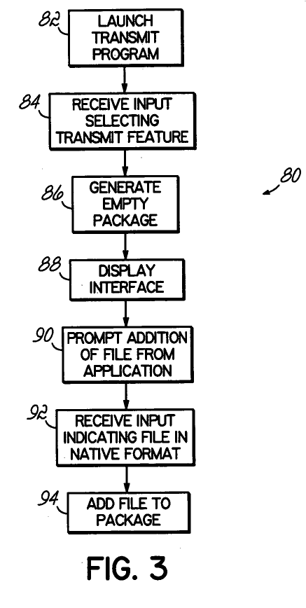

FIG. 3 includes process steps executable by the client computer 12 of FIG. 2 for the purpose of creating a package having file data that comprises an application file attached in its native format. Native format generally includes an application format other than PCL such as .doc Word, .wpd WordPerfect, H⁸ PowerPoint, .xls Excel, etc. The exemplary steps of the flowchart 80 presume that all applicable program code has been installed on the client computer 12, such as a secure communication program 25 discussed above.

Turning particularly to block 82 of FIG. 3, the operating system 38 may launch the program code to generate and send a secure package. While shown in the flowchart 80 as preceding step 84, one skilled in the art will appreciate that the program code may be initiated concurrently with another step. For instance, the client computer 12 may concurrently receive user input at block 84 indicating a user's desire to securely communicate a package to another party. Receipt of the input at block 84 may include prompting the user to select a “new package” button of an email analogous interface. Such an interface may have been displayed in conjunction with the communications program 25 initiating at block 82.

In response to receiving the input from the user at block 84, the operating system 38 may create a new package at block 86 of FIG. 3. An interface display indicative of the package created at block 86 will be displayed to the user at block 88. While discussed in greater detail below, the interface displayed at block 88 may include features characteristic of a typical email application interface. For instance, the interface may display fields where a sender may add a subject title, as well as text and an attachment. Such additions, updates and other augmentations to package made via the interface may all comprise file data of the package.

More specifically, an attachment field of the interface displayed at block 88 allows a user to add a file from the application to the file data of the package. In the specific example of the flowchart 80, the format of the file data is in native format when respectively prompted and received by the client computer 12 at blocks 90 and 92. The operating system 38 ultimately adds the file to the package at block 94 in response to the user's request at block 92.

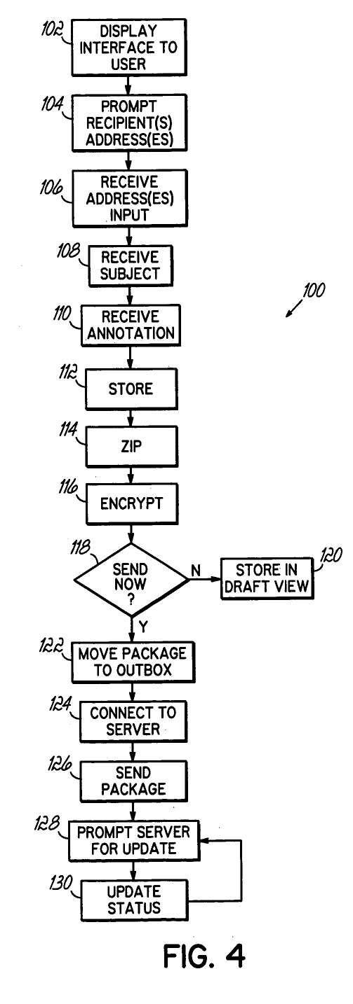

The flowchart 100 of FIG. 4 includes method steps configured to send the package created according to the processes of FIG. 2 or 3. Namely, the processes of block 102 of FIG. 4 that include displaying an interface to the user begin after creation of the package. The interface displayed at block 102 includes a field that displays an indication of the presence of the attachment of the PCL or native file. One skilled in the art will appreciate, however, that other packages may include no attachments. As discussed herein, the interface displayed to the user at block 102 may additionally include a field for inputting an email address for each intended recipient of the package. As such, the interface prompts the user at block 104 of FIG. 4 to enter the appropriate address(es) at block 106. Similarly, the client computer 12 may receive a subject description from the user that is associated with the package to be transmitted. The subject may be displayed to an addressee when initially presented with or otherwise notified of an arriving package. Textual annotations may be received by the client computer 12 at block 110 and stored along with the subject, addresses and other file data at block 112.

Compression and encryption programs of the secure communication program 25 may be used by the operating system 38 to process the package at blocks 114 and 116, respectively. The client computer 12 may then present the sender with an option to securely transmit the encrypted/compressed package at block 118. For instance, the email interface displayed to the user may include a “send” button that the user may click-on or otherwise select to initiate communication to a secure server 14.

Should the user elect to delay sending the draft package, the client computer 12 may store the package in draft view 35 at block 120. If the user alternatively decides to send the package at block 118, then the package is stored in an outbox 46 of the client computer 12 at block 122. Background processes running on the client computer 12 may detect the presence of the package in the outbox 46 and initiate connection to a server 14 at block 124. As discussed herein, this server connection may comprise a https secure socket layer network connection. Such secure connections typically employ independent encryption technologies for safeguarding transmitted data. In one sense, an embodiment of the present invention thus capitalizes on the availability of secure https socket technology to further safeguard package file data. After a connection is established at block 124, the package is sent at block 126 to the secure server hub 14.

Subsequent to sending the package at block 126, the client computer 12 may prompt the server computer 14 for status information at block 128. Such status information may include information relating to the user whether the package has been, for example, opened by the addressee, delivered but unopened, and/or deleted by the addressee. Specific status categories comprising such information may include: pending, received, failed, overdue and archived status indicators. The client computer 12 may accordingly update a status field of the same or another interface displayed to the user at block 130 to relate the status of the package(s). For instance, a confirmation of delivery status of the package may be delivered from the server 14 to the client 12 over a server network connection of the public Internet. Status of the package may thus be continuously communicated to a user in near real time.

Where desired, the status indicator of the interface may be broken out according to a group of addressees receiving the package or a single package addressee. For instance, one status indicator may show a user that a package has been successfully delivered to a number of different addressees. A different status indicator may show the user which addressees have actually reviewed, deleted or otherwise interacted with a package sent to their individual email account.

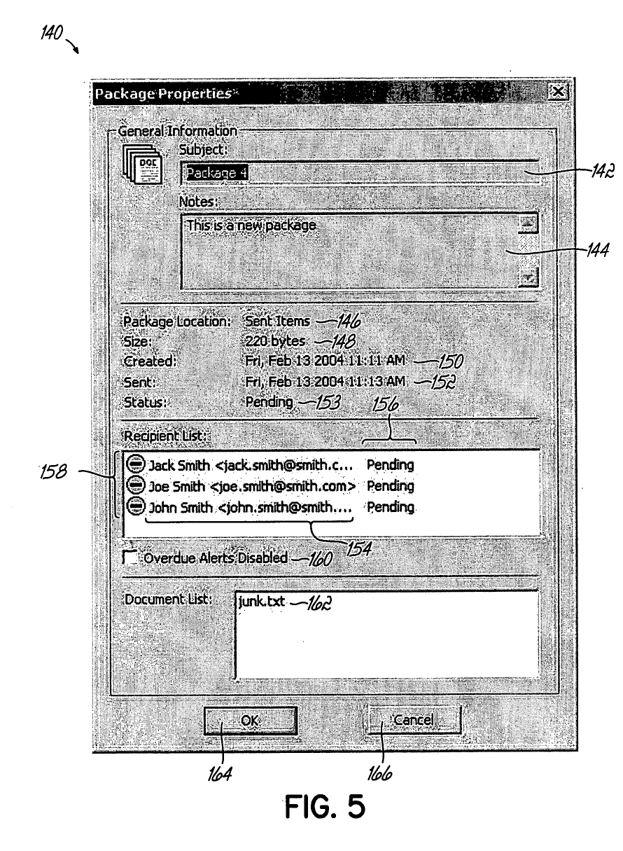

FIG. 5 shows an exemplary email interface screen 140 configured to relate to a user information pertaining to a newly generated package and it associated file data. Such an interface 140 may be displayed by a client machine 12 during package generation, such as at step 88 of FIG. 3. As shown in FIG. 5, the interface screen 140 includes a subject line 142. The subject line 142 accepts input typed in by a client and used to identify a sent package by its subject line.

While one skilled in the art will recognize that a suitable interface may include numerous display and interactive features per application specifications. The email interface screen 140 shown in FIG. 5 provides familiar fields and other features analogous to a conventional email application. Such familiarity allows a client to comfortably create, review and modify a generated package as they might a conventional, non-secure email message. Of note, the email interface screen 140 is not a browser application. It is rather a package application interface generated by the operating system 38 of the client computer 12.

The interface screen 140 also includes a notes section 144 in which a user may type in, copy/paste or otherwise cause a text message to be included in the file data of the package. Other information displayed in the interface screen 140 may include the directory location 146 and size 148 of the package, as well as the time it was created 150 and sent 152. Still other information may include the status 153 of the package.

The recipient list 154 shown in FIG. 5 includes the name and email address of each intended recipient of the package. While the global status 153 of the message may relate to the aggregate status of all recipients, individual status indicators 156 associated with each addressee shows the status of the package with regard to an individual addressee. The exemplary interface screen 140 further includes symbols 158 indicative of the package status. Such symbols may allow a user to see at a glance whether a package has been received and/or opened by an addressee, for instance.

Another feature shown in the interface screen 140 regards an overdue alert. An overdue alert may comprise an email or other message that is automatically sent to the sender of a package should the package remain unopened for a period of time exceeding some pre-determined duration. Such an overdue alert may be disabled by selecting block 160 of FIG. 5.

A document list shown in field 162 of the interface 140 reveals the name of a file attachment of the package. “OK” and “Cancel” buttons 164, and 166, respectively, of the interface screen 140 allow a user to approve or discard a draft package using the interface screen 140. The interface screen 140 thus provides a user with a mechanism to change file data of a package using a familiar email format, including import, drag and click features, as well as keyboard mechanisms and mouse commands.

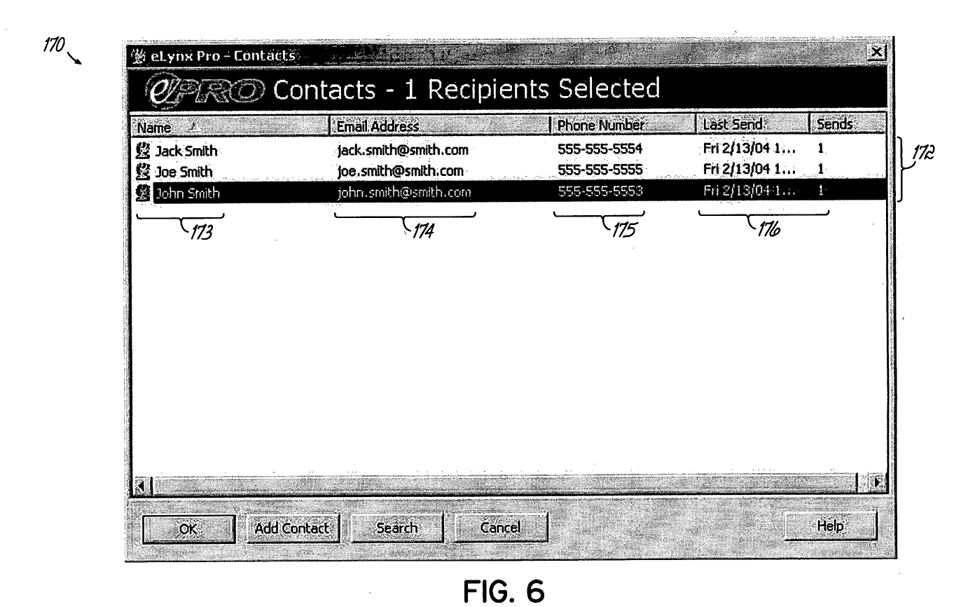

FIG. 6 shows an exemplary interface screen 170 that includes contacts comprising name and address information 172 associated with addressees. Such information 172 may include a name 173, an email address 174, a phone number 175, as well as information 176 relating to if and how many packages have been sent previously. Contact information 172, such as the email address 174 of an addressee 173 may be automatically loaded into a recipient field 154 of a package interface 140, such as that shown in FIG. 5. For instance, a sender may cause contact information 172, including an email address 174, to automatically populate an addressee field of a package by double clicking the appropriate information 172 of the contact interface screen 170. Choosing an addressee from an interface screen 170 may have particular application as discussed above in the context of block 106 of FIG. 4.

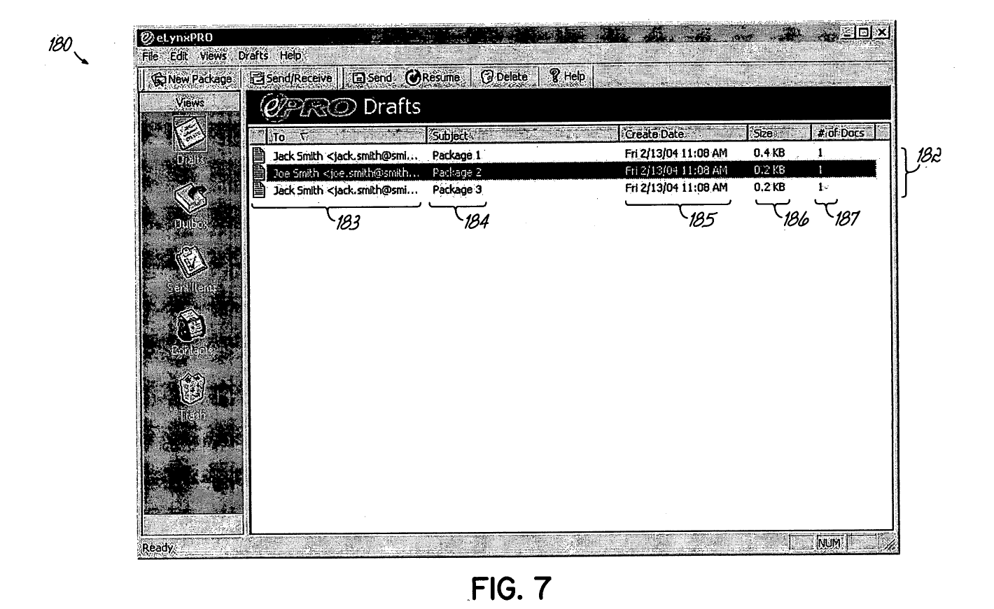

FIG. 7 shows exemplary interface screen 180 configured to communicate to a user a number of draft packages stored in memory 35. Selection of existing drafts may have particular application as discussed above in connection with attaching a PCL to an existing package draft, such as at block 66 of FIG. 2. The interface screen 180 shows a listing of such packages 182 that includes for easy user reference a name 183 of the addressee, a subject 184 of a package, as well as the date 185 the package was created, the package's size 186 and number of attached document files 187.

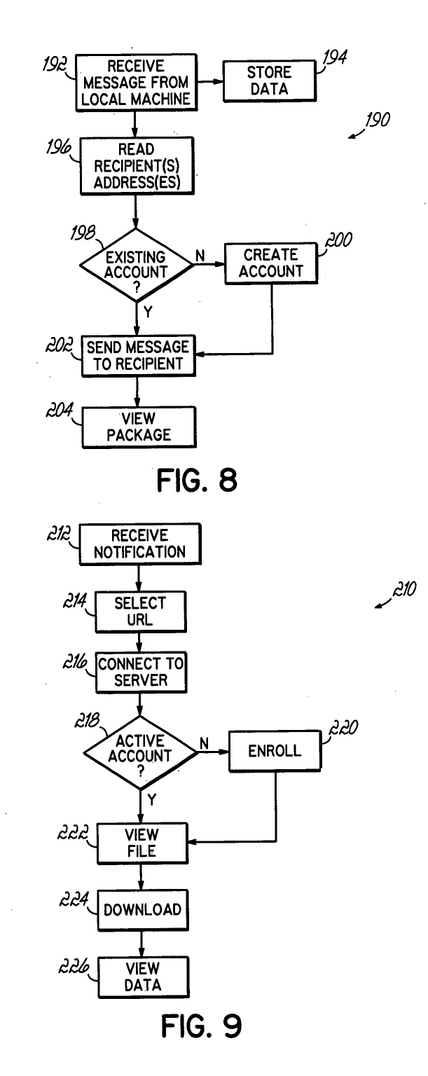

FIG. 8 shows a sequence of exemplary method steps suited for execution by the server computer 14 of FIG. 1. More particularly, the steps of a flowchart 190 are configured to receive an encrypted package from the client computer 12 and securely communicate it to an addressee. To this end, the server computer 14 may receive a package over a secure link from the client computer 12 at block 192 of FIG. 8. The package received from the client computer 12 may be stored at the server computer 14 at block 194 of FIG. 8.

The server computer 14 at block 196 may concurrently read one or more addresses associated with the package received at block 192. The address read by the server computer 14 at block 196 may be compared to a stored list at block 198 to determine if the addressee has an existing account. Insuring that the addressee has an account may assist in billing and other accounting endeavors, as well as in determining whether the addressee requires a download of software used for unbundling, or decompressing and/or decrypting the package on their local computer.

If it is determined that the addressee does not have a valid account at block 198, then such an account may be created for the addressee at block 200 of FIG. 8. Such enrollment processes may include assignment of a password, as well as installation of decompression and decryption program code on their local computer. That is, a sender's account may be checked upon any posting to ensure that the account is still valid. If not, a dialog box may indicate to the user that their account is no longer valid. A link to a webpage allowing the user to reactivate their account will typically then be provided. The sender will generally not have the ability to post until the account has become reactivated.

Once the existence of an account is established at block 198 or 200, then the package is sent to the addressee at block 202. Sending the package at block 202 may include sending an email from the server computer 14 that includes a Uniform Resource Location (URL) link. A URL is a term for a generic Internet location identifier. The URL identifies an address within a distributed network system. The user may click on the URL link to initiate a process for viewing for the package on their local computer at block 204. In another embodiment, the package may be automatically sent over the secure network connection to the addressee in an email. In either case, the addressee may view the package at block 204 on their local computer in an email application template similar to that shown in FIG. 5.

FIG. 9 shows a sequence of exemplary method steps taken by a recipient addressee to view package file data. At block 212 of FIG. 9, the addressee may receive notification that they have a package addressed to them. As discussed herein, such notification may comprise an email message or dialog box displayed on their local computer. Where the email message includes a URL, the addressee may select the URL at block 214. This selection at block 214 may cause the computer of the addressee to transparently connect to the secure server over the secure connection at block 216 of FIG. 9. If the addressee does not have an active account at block 218, then the addressee may need to first enroll at block 220. As discussed herein, the processes of block 220 typically include password assignments, as well as the downloading of decompression and decryption program code on their local computer.

At the secure server 14, the addressee may select one or more packages in their account inbox that they wish to view at block 222. Clicking on or otherwise designating a desired, received package may cause the download at block 224 of the package. Such download selection at block 224 may cause the program code to decompress/unzip and decrypt the downloaded package in order to make it viewable at block 226. As discussed herein, viewing the interface display of the package may cause a status associated with the package to be updated on either or both the server computer 14 and the sender's client computer 12. Another status designation at the server computer 14 associated with the addressee's account may be modified to indicate to the addressee on a subsequent session that the package has already been viewed.

Where so configured, items having a status received that is older than a specified time period may be moved to trash, or purged. Views available for display to a user may include information pertinent to the use of drafts, an outbox, sent items, trash and contact groupings. In all views, information may be searched and rearranged by dragging or clicking on toolbar icons and other menu items. Fields may be automatically populated where possible to save the sender from entering in information stored in other memory of the server or system.

While the present invention has been illustrated by a description of various embodiments, and while these embodiments have been described in considerable detail, it is not the intention of the applicants to restrict or in any way limit the scope of the appended claims to such detail. For instance, while the exemplary sequence of steps shown in FIGS. 2-4, 8 and 9 may have particular utility in certain contexts, it should be understood that the order and content of such steps may be rearranged, omitted, augmented or otherwise modified to suit alternative embodiments and application requirements. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of the applicants' general inventive concept.

1. A method for communicating a secure electronic communication comprising:
generating a package using a non-browser application on a local computer, the package configured for electronic transmission that includes an electronic mail analogous interface, file data and an address associated with an addressee having a public electronic mail account;
communicating the package from the local computer to a secure server over a secure network connection over the public Internet;
storing the package at the server in association with the electronic mail account of the addressee;
communicating the package to the addressee;
decrypting the package; and
displaying the package to the addressee.

2. The method of claim 1, further comprising encrypting the package at the local computer of a sender.

3. The method of claim 2, wherein encrypting the package at the local computer of the sender further includes using a public key to encrypt the package.

4. The method of claim 1, wherein decrypting the package further includes using a private key associated with a public key previously used to encrypt the package.

5. The method of claim 1, further comprising storing the package as a draft package at the local computer prior to communicating the package to the secure server.

6. The method of claim 1, further comprising causing the addressee to be notified of the package using the public electronic mail account.

7. The method of claim 1, wherein communicating the package to the addressee further includes communicating the package using at least one of the secure network connection and a second secure network connection.

8. The method of claim 1, wherein generating the package further includes configuring the interface to be responsive to user input.

9. The method of claim 1, wherein generating the package further includes configuring the interface to display a status of the package.

10. The method of claim 1, wherein generating the package further includes adding additional file data to the package.

11. The method of claim 1, wherein generating the package further includes including a PCL file within the file data.

12. The method of claim 1, wherein displaying the package further includes downloading the package from the secure server.

13. The method of claim 1, wherein displaying the package further includes automatically downloading the package from the secure server.

14. The method of claim 1, further comprising compressing at least a portion of the package.

15. The method of claim 1, wherein communicating the package further includes communicating the package over a https socket layer connection.

16. A method for communicating a secure electronic communication comprising:
generating at a local computer using a non-browser application configured for electronic transmission that includes an electronic mail analogous interface, an encrypted package comprising file data and an address associated with an addressee having a public electronic mail account; and
transmitting from the local computer the package over a secure network connection over the public Internet.

17. The method of claim 16, further comprising storing the package in association with an electronic mail account of the addressee.

18. The method of claim 16, further comprising communicating the package to the addressee.

19. A method for communicating a secure electronic communication comprising:
receiving over a secure network connection over the public Internet a package, using a non-browser application that includes an electronic mail analogous interface, the package configured for electronic transmission and comprising file data and an address associated with an addressee having a public electronic mail account, wherein the package has been stored remotely at a secure server;
decrypting the package; and
displaying the package to the addressee.

20. A method for communicating a secure electronic communication comprising:
generating a package for electronic transmission using a non-browser application that includes an electronic mail analogous interface;
encrypting the package;
communicating the package from the local computer to a secure server over a secure network connection over the public Internet wherein the package is stored at the server and communicated to an addressee; and
communicating a confirmation of delivery status of the package from the secure server to the non-browser application at the local computer via a secure network connection over the public Internet.

21. An apparatus comprising:
a local computer;
a server computer configured to communicate with the local computer over a secure network connection; and
program code in communication with at least one of the local and server computers, the program code configured to generate a package using a non-browser application on the local computer, the package being configured for electronic transmission that includes an electronic mail analogous interface, file data and an address associated with an addressee having a public electronic mail account, the program code being further configured to communicate the package from the local computer to the secure server over the secure network connection, and to store the package at the server in association with the electronic mail account of the addressee, the program code being further configured to decrypt and communicate the package to the addressee.

22. The apparatus of claim 21, wherein the secure network connection includes a https socket layer connection.

23. The apparatus of claim 21, wherein the program code initiates encrypting the package at the local computer of a sender.

24. The apparatus of claim 23, wherein the program code initiates using a public key to encrypt the package.

25. The apparatus of claim 21, wherein the program code initiates using a private key associated with a public key previously used to encrypt the package.

26. The apparatus of claim 21, wherein the program code initiates storing the package as a draft package at the local computer prior to communicating the package to the secure server.

27. The apparatus of claim 21, wherein the program code initiates causing the addressee to be notified of the package using the public electronic mail account.

28. The apparatus of claim 21, wherein the program code initiates communicating the package to the addressee using at least one of the secure network connection and a second secure network connection.

29. The apparatus of claim 21, wherein the interface is configured to display a status of the package.

30. The apparatus of claim 21, wherein the file data includes a PCL file.

31. The apparatus of claim 21, wherein the program code initiates automatically downloading the package from the secure server.

32. The apparatus of claim 21, wherein the program code initiates compressing at least a portion of the package.

33. An apparatus comprising:
a computer; and
program code in communication with the computer, the program code using a non-browser application and including an electronic mail analogous interface configured to receive from a remote computer over a secure network connection over the public Internet an encrypted package comprising file data and an address associated with an addressee having a public electronic mail account, the program code being further configured to store the package in association with an electronic mail account of the addressee and to communicate the package to the addressee.

34. An apparatus comprising:
a computer; and
program code in communication with the computer, the program code configured to receive over a secure network connection over the public Internet a package generated using a non-browser application that includes an electronic mail analogous interface, the package being configured for electronic transmission and comprising file data and an address associated with an addressee having a public electronic mail account, wherein the package has been stored remotely at a secure server, the program code further configured to decrypt and display the package.

35. An apparatus comprising:
a computer; and
program code in communication with the computer, the program code configured to generate a package using a non-browser application that includes an electronic mail analogous interface, the package being configured for electronic transmission, the program code further being configured to encrypt the package and to communicate the package from the computer to a secure server over a secure network connection over the public Internet, wherein the package is stored at the server and communicated to an addressee, wherein the program code is further configured to communicate a confirmation of delivery status of the package from the secure server to the non-browser application at the local computer via a secure network connection over the public Internet.

36. A program product, comprising:
program code in communication with at least one of a local and a server computer, the program code configured to generate a package using a non-browser application that includes an electronic mail analogous interface on the local computer, the package being configured for electronic transmission comprising file data and an address associated with an addressee having a public electronic mail account, the program code being further configured to communicate the package from the local computer to the secure server over a secure network connection, and to store the package at the server in association with the electronic mail account of the addressee, the program code being further configured to decrypt and communicate the package to the addressee; and
a signal bearing medium bearing the program code.

37. The program product of claim 36, wherein the signal bearing medium includes at least one of a recordable medium and a transmission-type medium.
